(19) United States
(12) Patent Application Publication
(10) Pub. No.: US 2003/0171970 A1
(43) Pub. Date: Sep. 11, 2003

(54) Project scheduler interface

(76) Inventor: Robert Kinsella, Oneida, NY (US)

Correspondence Address: William J. Sapone, Esq., Coleman Sudol Sapone P.C., 714 Colorado Ave., Bridgeport, CT, 06605, US

(21) Appl. No.: 10/185,819

(22) Filed: Jun. 26, 2002

Related U.S. Application Data
(60) Provisional application No. 60/363,578, filed on Mar. 11, 2002.

(51) Int. Cl. G06F 17/60

(52) U.S. Cl. 705/9

(57) ABSTRACT

A computer system has a work order software program component, a project scheduling software component and an integration software program component for integrating project tasks with scheduled maintenance so as to optimize completion of the project tasks.

### CROSS REFERENCE TO RELATED APPLICATION

This application claims priority in U.S. provisional patent application serial No. 60/363,578 filed Mar. 11, 2002.

### TECHNICAL FIELD

This invention relates to a maintenance and project scheduling system and more particularly to a software system which interfaces a maintenance work order generation software program with a project scheduling program so as to generate and update work orders for completing project tasks.

### BACKGROUND

Computer software systems are available to assist a job planner in generating work orders. Typically, such work orders are generated on an “as needed” or emergency basis, to deal with day to day maintenance of a facility, or as part of a preventative maintenance program.

Occasionally, major projects may be undertaken, such as overhaul of a particular unit during a production outage or as part of a planned facility expansion. Typical project planning will involve determining a project schedule, integrating the various tasks to be completed and the order in which they must be completed. Various software programs are available to assist in project scheduling. However, no system exists which integrates the project scheduling function with a work order system. Consequently, work orders are generated, on an as-needed basis, to complete project tasks. However, this can cause scheduling delays if conflicting work order priorities require deviating from the schedule, as well as requiring manual updating of project milestones, complicating project monitoring.

### SUMMARY OF THE INVENTION

It is an object of the present invention to provide a combined maintenance and project scheduling software system so as to integrate project work order generation with maintenance scheduling to improve efficiency.

It is a further object to provide a project planning interface for planning and scheduling tasks for completing a project and then for integrating the tasks with maintenance planning to coordinate tasks, trades and materials to optimize task completion.

The invention is a computer system for project and maintenance scheduling using an integration software component that effectively links a work order generation software system with a project scheduling system to integrate the necessary project work orders with other generated work orders so as to optimize labor utilization while meeting the project schedule. Information from the project scheduling program is also used to populate fields in the work order generation system, such as relating to the time and trades to complete various tasks, and conversely, data may be transferred from the work order system to the project scheduling system for effective and timely project tracking.

Using the present invention, project scheduling is optimized, thus improving execution of the project itself. Further, as tasks are completed, the data which is relayed back to the scheduling program via the work order system can be used to make adjustments and modifications to the schedule as needed to accommodate the actual work realities, for fine tuning the project schedule. This type of interface improves the overall effectiveness of the project management function, while accommodating the day to day variations in maintenance resource allocation.

### BRIEF DESCRIPTION OF THE DRAWINGS

FIG. 1 is an overview of an integrated computer system for maintenance project scheduling.

FIG. 2 is a view of a typical start up menu display of a project/maintenance interface.

FIG. 3 is a view of a typical work order query screen display.

FIG. 4 is a view of a typical build where clause screen display.

FIG. 5 is a view of a typical preventative maintenance screen display.

FIG. 6 is a view of a typical create work order screen display.

FIGS. 7a, 7b and 7c show the project displays.

### DETAILED DESCRIPTION OF THE INVENTION

The invention is detailed in the following disclosure and drawings which comprise logic information and views of various screens encountered by a user of the interface system.

In one embodiment of the invention, the work order system is a commercially available software package known as MAXIMO, obtained from MRO software and the project system is a commercially available software program known as Project 2000 obtained from Microsoft Corp. While useable with the interface of the present invention, the invention is not limited thereto, as the basic purpose is to provide an interface between two such software packages such that data in the work order system can be copied into the project scheduling system as well as copying data into the work order system from the project scheduling system.

The interface may be written in Visual basic for Applications, which is part of the project 2000 software package, though other languages may be used.

The interface creates tasks, assignments, and resources in the project scheduling program which are then used in the work order program. The interface enables a project manager to detect and update tasks in the scheduling program based on competed work orders in the work order program, updates and gives progress status for tasks in the project schedule from actual work order data, and updates schedule dates for the work orders issued based on project scheduling needs such that work orders may be generated in draft from scheduled project tasks in advance. This facilitates integration of the project work orders with the work orders for routine and preventative maintenance.

The user, who may be a project manager or project scheduler, may use any selection criteria for selecting work orders, such as selecting crafts from the work order plans, and the user may also bring over a work order hierarchy and sequence from the work order system. The user may select job plans used with preventive maintenance as well, and modify the necessary work orders as needed for integration into the project schedule, enabling the user to read actual work order records such as for labor used, dates of work and cost.

As one example, a project may have as one task relocating a piece of existing equipment. The user may refer to the work order system to identify work orders related to at least the removal of the equipment and then use the prior work order information to generate at least a draft work order for the project. This will also provide information on the time and trades necessary to effect the removal. Since the user may access and review actual work order records in developing the project schedule, such as for labor used, dates of work and cost, the user is provided with a ready resource for preparing a project schedule. The user is also provided with necessary feed back on project work orders to monitor project progress and to refine the project schedule as needed going forward to complete future tasks, such as by adjusting target dates, duration and status. The ability to change the status of a work order, create material reservations or modify a material reservation based on the work orders completed or to maintain project schedule is particularly useful to the project manager.

An additional advantage is that the project planner has access to the proposed maintenance schedule, and can identify opportunities in the maintenance work order schedule to coordinate work. If a pump is to be out of service for maintenance, the project planner may utilize the equipment down time for completing tasks in his schedule which call for the same equipment outage. This coordination also works to the advantage of the maintenance planner, who may similarly schedule tasks for completion during project required outages. The net effect is limited down time and disruption of production.

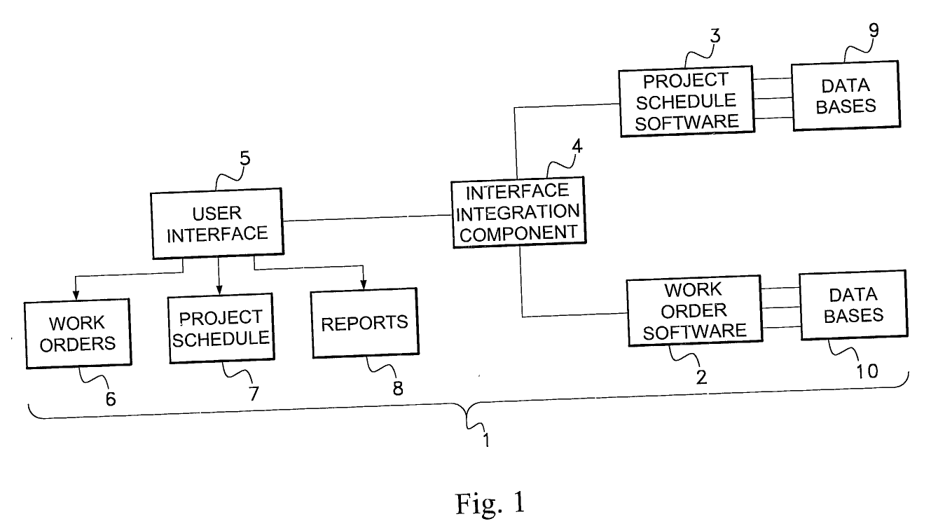

Referring to FIG. 1, the invention is a computer system 1 for maintenance and project scheduling comprising a first software program 2 for generating work orders and a second software program 3 for project scheduling and an interface software program 4 for exchanging data between the first and second software programs so as to integrate project scheduling with the generation of work orders needed to complete project tasks and to obtain feedback on work completed to monitor project progress. A user interface 5, typically a computer terminal, provides access to the software programs, such that a user can generate work orders 6, a project schedule 7 and/or print out various reports 8. The software programs generally have access to related databases 9 and 10, though more databases could also be accessible by the programs. Of course, more than one user interface may be available for use by various persons involved in project and/or maintenance planning.

The computer system user interface 5 has access to the first program, the second program and the interface program, having means for displaying screens for the user to navigate between the first and second software systems, so as to integrate data for generating work orders, generating a project schedule, updating or modifying the project schedule and/or work orders, and integrating or exchanging data therebetween.

The various databases linked to the software programs typically contain time, material, cost, labor, trade and equipment information to support project scheduling and work order generation.

The detailed information on one embodiment of the system follows. However, the invention is not limited by the specific steps utilized in the following description example, and it will be understood by those skilled in the art that various changes or modifications can be made without varying from the scope of the present invention.

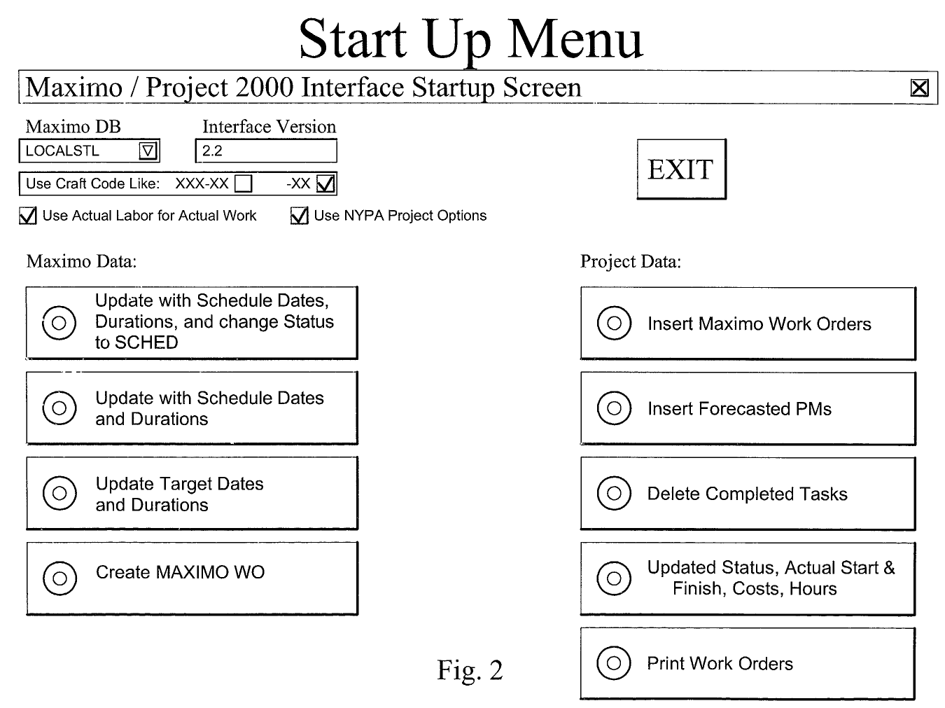

Referring to FIG. 2, the Main Screen display is shown. The screen identifies the data base used with the project and the date. The display includes various push buttons, as well as drop down lists including work order databases and test databases. The interface has the ability to read and update multiple data bases. The Interface Version number of the program is displayed as well. When this changes, the program automatically updates with the new version.

The “Use Craft Code Like: XXXX-XX □-XX □” bar is used when importing Work Orders. The user may use the entire craft code or strip out characters 5 and 6 which relate to Level, strip out characters 7 and 8 which relate to Skill, or strip all characters 5, 6, 7 and 8, depending on the boxes selected.

The system has the ability to use a stored user defined set of options which may relate to a particular type of project or facility. These may be selected as default settings for the Tools, Options, Schedule Tab, etc.

The “Use Actual Labor for Actual Work” check box allows a user to use the actual labor data from the labor transactions table and automatically splits tasks.

Under the heading for “Project Data”, there are various buttons which interact with project data only. There is the capability to read data from the work order databases, or from multiple databases.

Under the heading for “MAXIMO Data”, there are various buttons which interact with the work order data, and which allow writing project dates and variations in the schedule, updating the databases and creating work orders.

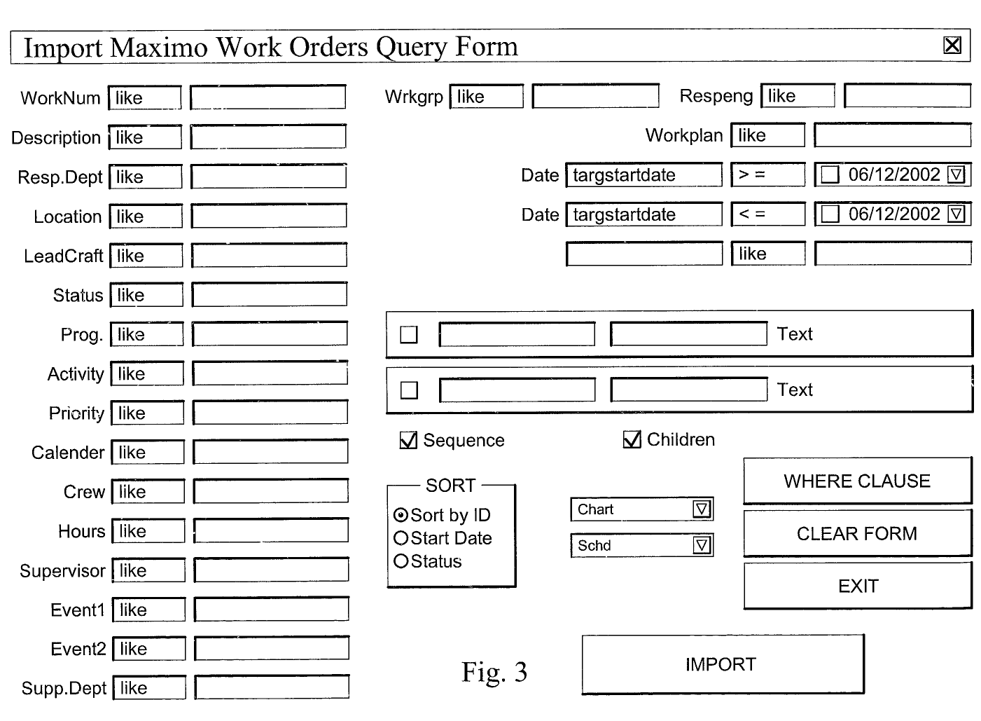

Referring to FIG. 3, the work order query screen is shown for importing Work Orders.

The Query screen uses operands such as (=, !=, >=, <=, >, <, Like, Not Like, In, Not In, Is, Is Not), and has field values such as: Text, Dates, or Numbers, which may be selected from drop down lists (Value Lists) or calendar drop down. All fields are from the Work Order table except the Craft which is from the Work Plan. The user can also select work order fields to map directly to project fields.

The “Use WO Sequence in WBS” check box is used if a Work Order is part of a sequence. The import will then use the predecessor field to set up the tasks in the same order.

The “Include Children” check box is used if a work order in the selection set has sub work orders. Then, all of the sub work orders will be included in the import.

The “Sort Results By” button gives options as to the results of the import and the existing project that the data was read into may be sorted by ID; Start Date; Status, Start, etc. The status order is (INPRG, SCHED, POMATREC, WMATL, PLANCOMP, all other statuses).

The “Default Task View” allows the user to pick the view & table for the project to use to display the results of the import.

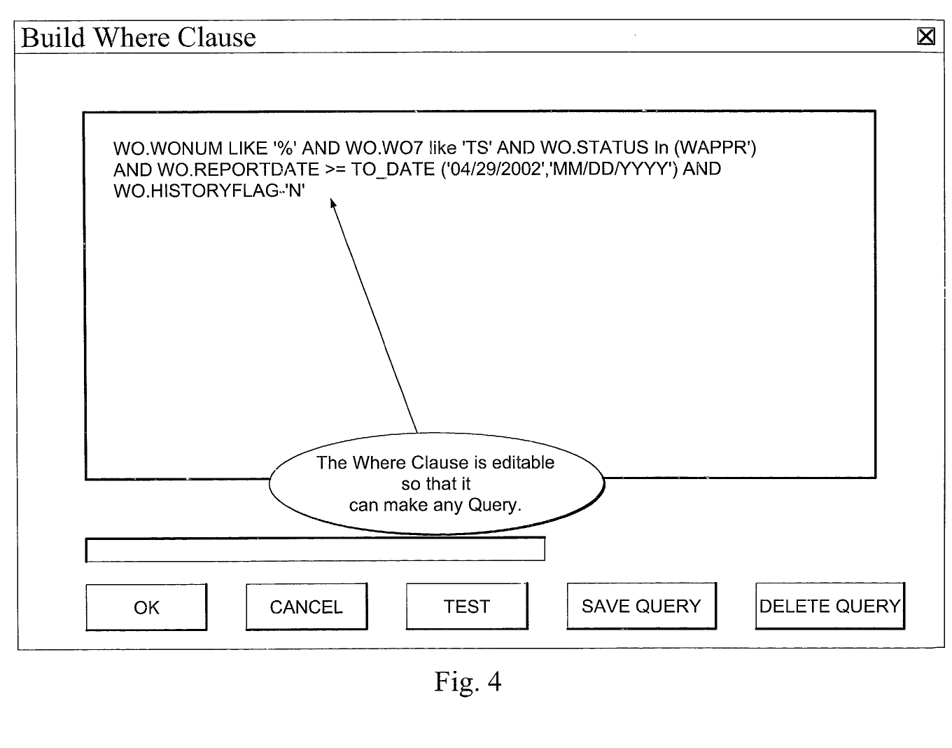

The “Where Clause” button enables a screen entry to enter a customized “where clause”. (See FIG. 4).

The “Clear Form” button clears all the field entries.

The “Import Form Maximo” button reads in data from the work order system based on field entries or the “where clause”.

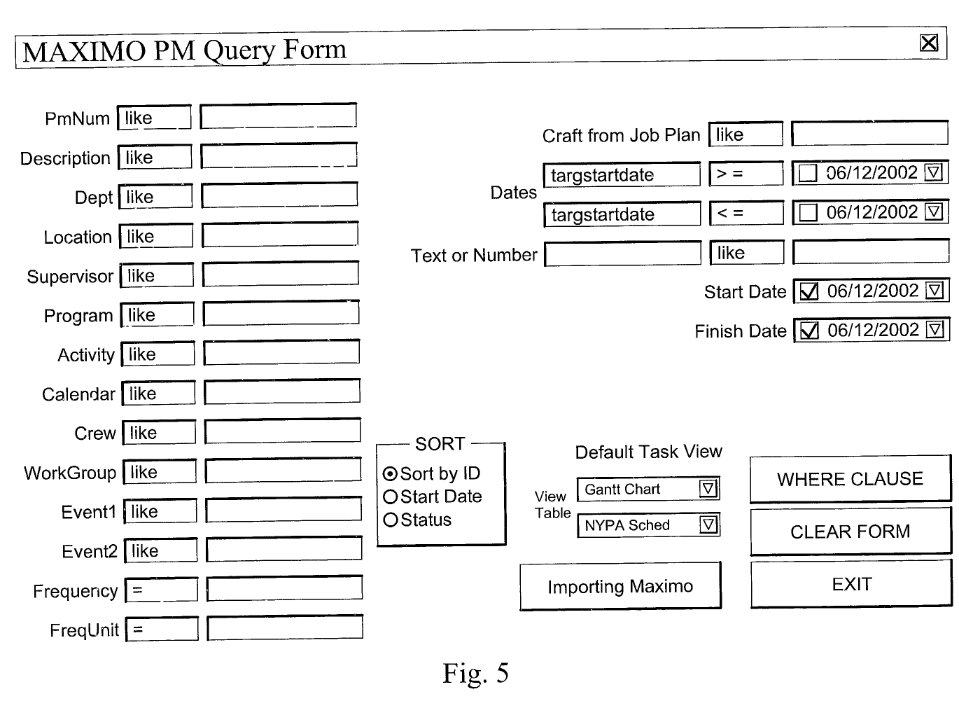

Referring to FIG. 5, the PM Query Screen display is shown which is comparable in arrangement to the Work Order Query Screen.

In reading in imported data, the following occurs: The system reads in work order date (label displays “WoNum”) to a temporary table. The system reads in work plan labor data (label displays “WpLabor”) to a temporary table. The system reads in sub work orders of select work orders (label displays “Children”) to temporary table. The system then builds an assignment table in the temporary table from the work plan date (label displays “Assignments”), with a sum of craft and a sum of hours.

The system builds resource pool (label displays “Crafts”) in a temporary table only if a current project doesn't use a common resource pool, and sums craft and counts only crafts with STATUS not equal to INACTIVE (see Labor screen). The Cancel button is active up to this point. The system merges data from the temporary table (Tasks, Assignments, Resources) into an active project and builds WBS (Sub Work Orders) for data imported (label displays “WBS”). The system builds predecessors using the Work Order Sequence for data imported (label displays “Predecessors”), and reads in actuals—Labor and Costs (label displays “Tasks”). The cost calculations are turned off. The user has the option to Use Actual Labor for Actual Work turned on.

Task duration is calculated based on the assignments and calendar active. If there is no assignment, then the system uses the Estimated Duration from MAXIMO. The system only reads in NEW Work Orders to the active project. If the Work Order is already present in the project, it does NOT read in the information again. The system then populates the Start date of the task with the Actual Start Date, if there is no value for that then it uses the Scheduled Start Date, if there is no value for that then it uses the Target Start date, and if there is no value for that then it uses the Project Start date which would be the day the project was created.

If the user has the option, Use Actual Labor for Actual Work is turned on, this automatically splits tasks based on the dates of the labor records. The system uses the first Labor transaction date as the Actual Start Date, uses the last Labor transaction date as the Actual Finish Date if MAXIMO has a Actual Finish date value. If the user doesn't have the option “Use Actual Labor for Actual Work turned on”, if the last date of the calculated actual labor hours (total labor hours+start date of task) is less than the Scheduled Start date (from MAXIMO), then the system will split the task from that date to the scheduled start date. If the user does have the option on, it does the same thing except it uses the last labor transaction's date for the split.

If the Actual Labor hours exceed the duration and there is NO Actual Finish Date, then the program adds 1 hour to the assignments to make them longer than the actual labor hours. Note that the constraint is always set to Start No Earlier Than. Examples:

Select by Dept and Status;

Select using Where Clause to include History Records;

Select Work Orders using Craft from Work Plan;

Select Work Order with WO Hierarchy;

Use operand IN;

Show difference between using Actual Labor records and Totals;

Show NULL example (Actual Labor with Work Order without craft code); and

Show example of Actual Finish date using Labor records when there is an Actual Finish Date

The Screen field properties for the PM import screen are the same as Work Order import except the fields are for the PM table. All fields are from the PM table except craft which comes from the job plan. The start date and finish date are required. The finish date must be greater than or equal to start date. The “Where Clause” may be custom built though SQL knowledge may be required.

The WoNum built is “PM−”+PmNum+“−#”; where # is the iterative number of each successive work order generated in the time frame (start to finish date).

The program uses the same logic as the Work Order System for generating work orders from the PMs.

Import From MAXIMO reads in data from the Work Order System based on field entries or “Where Clause” and calculates work orders to generate. The system reads in PM data (label displays “PM Number”) to the temporary table. Using work order generation from the PM logic, the system generates a task for each time the PM is due in the time frame specified. The system reads in job plan labor data (label displays “JpLabor”) for each PM generated to a temporary table and builds an Assignment table in the temporary table from the job plan data (label displays “Assignments”), with a sum of craft and sum of hours. The system builds a resource pool (label displays “Crafts”) in temporary table only if the current project doesn't use a common resource pool. The system sums craft and counts only crafts with STATUS not equal to INACTIVE (see Labor screen). The Cancel button is active up to this point. The system merges data from temporary table (Tasks, Assignments, Resources) into an active project. The constraint is always set to Start No Earlier Than and only reads in NEW PM generated work orders to the active project. If the PM is already present in the project, it does NOT read in the information again.

Examples:

Select by Dept

Select using Where Clause

Select PM using Craft from Job Plan

Use operand IN

The project has various user activated buttons such as updated Status, Actual Start & Finish, Costs, Hours, etc. With these buttons, costs calculations may be turned off. The user has the system updated with the existing tasks with the Work Order Status, Actual Start & Finish date, Costs, and Labor transactions.

If the user has the option “Use Actual Labor for Actual Work” turned on, this automatically splits tasks based on the date of the labor records, and uses the first labor transaction date as the actual start date, uses the last labor transaction date as the actual finish date, if the system has an Actual Finish date value.

If the last date of the actual labor hours is less than the Scheduled Start date, then the system will split the task from the last date with actual labor to the scheduled start date.

Examples:

Change dates in Work Order System.

Change Status in Work Order System.

Add Labor records in Work Order System.

There is also a button Delete Completed Tasks, which deletes from the active project all tasks that have a status of COMP, CAN, CLOSE, and WCLOSE in Project. This can be used in conjunction with Update Status, Actual Start & Finish, Costs, Hours button, etc.

Examples:

Change status of Work Order in MAXIMO, Update Status button, then use the delete completed tasks button.

There is also a Print Work Orders button which prints work orders for all or selected tasks, though different options are available according to a user's preferences.

The work order system also has various user actuated buttons, such as Update with Schedule Dates, Durations, and change status to SCHED.

These buttons allow a user to provide updates for the selected tasks or all tasks. The user must make the selection before using this button. If the current status in the work order system is WAPPR (or a synonym of WAPPR), then inventory reservations are created using the WPMATERIAL records for the work order, the status of the work order is changed to SCHED, the work order's scheduled start date is updated with the start date from project,

The work order's scheduled finish date is updated with the finish date from project, the work order's estimated duration is updated with the duration from project, the work order's remaining duration is updated with the remaining duration from project and the status (Text3) field in project is changed to SCHED.

If the current status is APPR, WSCH, WMATL (or a synonym of APPR, WSCH, WMATL), then inventory reservations are updated using the scheduled start date for the required date (if the scheduled start date has changed), the status of the work order is changed to SCHED (if the current status isn't already SCHED), the work order's scheduled start date is updated with the start date from project, the work order's scheduled finish date is updated with the finish date from project, the work order's estimated duration is updated with the duration from project, the work order's remaining duration is updated with the remaining duration from project and the status (Text3) field in project is changed to SCHED.

If the current status is INPRG (or a synonym of INPRG), then inventory reservations are updated using the scheduled start date for the required date (if the scheduled start date has changed), the work order's scheduled start date is updated with the start date from project, the work order's scheduled finish date is updated with the finish date from project, the work order's estimated duration is updated with the duration from project and the work order's remaining duration is updated with the remaining duration from project.

Every update also updates the WOSTATUS table (Work Order History Table). This will leave a history of who changed which dates in the work order system from this interface. If the current status is any other status, the work order is not updated.

Another button is the Update with Schedule Dates and Durations. This button performs the same functions as the previously described button (Update with Schedule Dates, Durations, and change status to SCHED) except that it does not change the status of the Work Order. It only updates the Scheduled Start and Finish Dates, Estimated Duration, Remaining Duration, and Inventory Reservations.

Other buttons include Update Target Dates and Duration. The user can provide updates for the selected tasks or all task. The user must make the selection before using this button. If the current status is WAPPR, APPR, WMATL, or WSCH (or a synonym of WAPPR, APPR, WMATL, or WSCH), then the work order's target start date is updated with the start date from project, the work order's target finish date is updated with the finish date from project, and the work order's estimated duration is updated with the duration from project. If the current status is any other status, the work order is not updated.

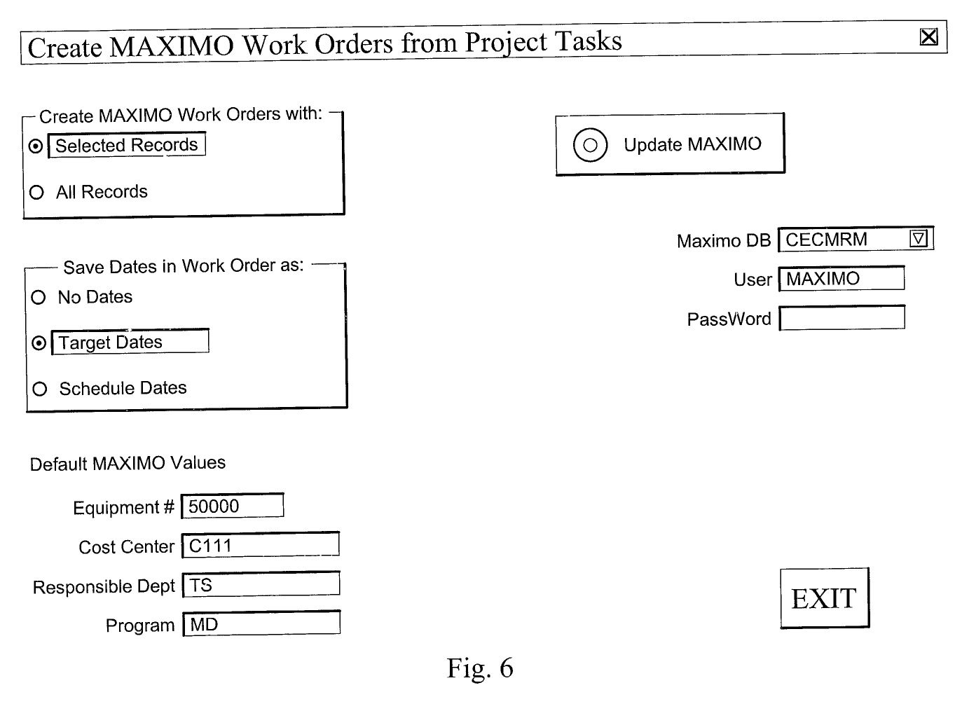

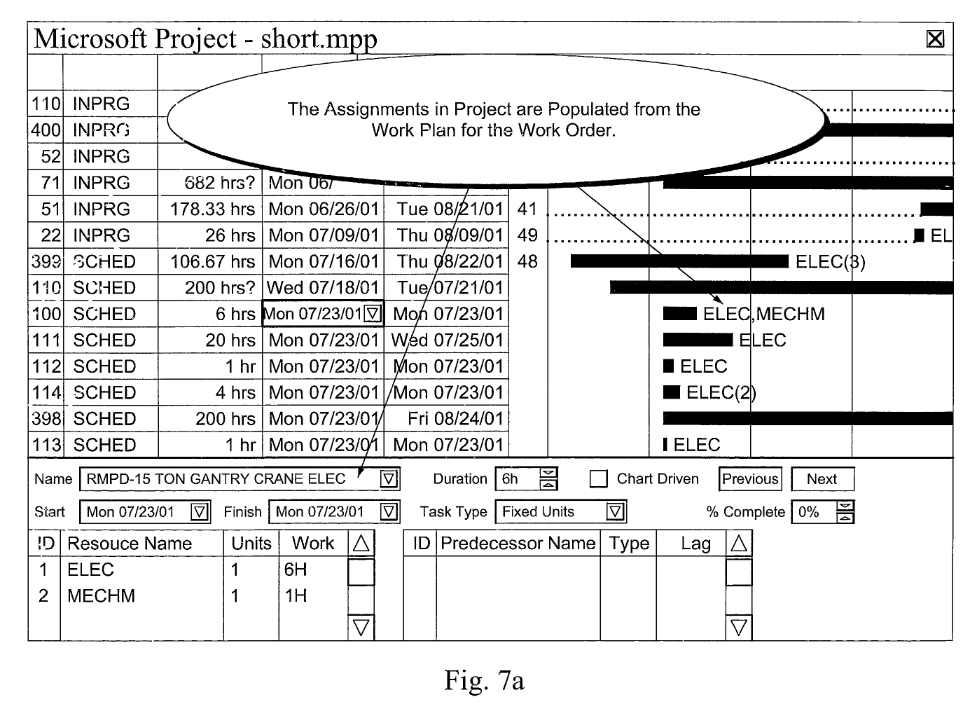

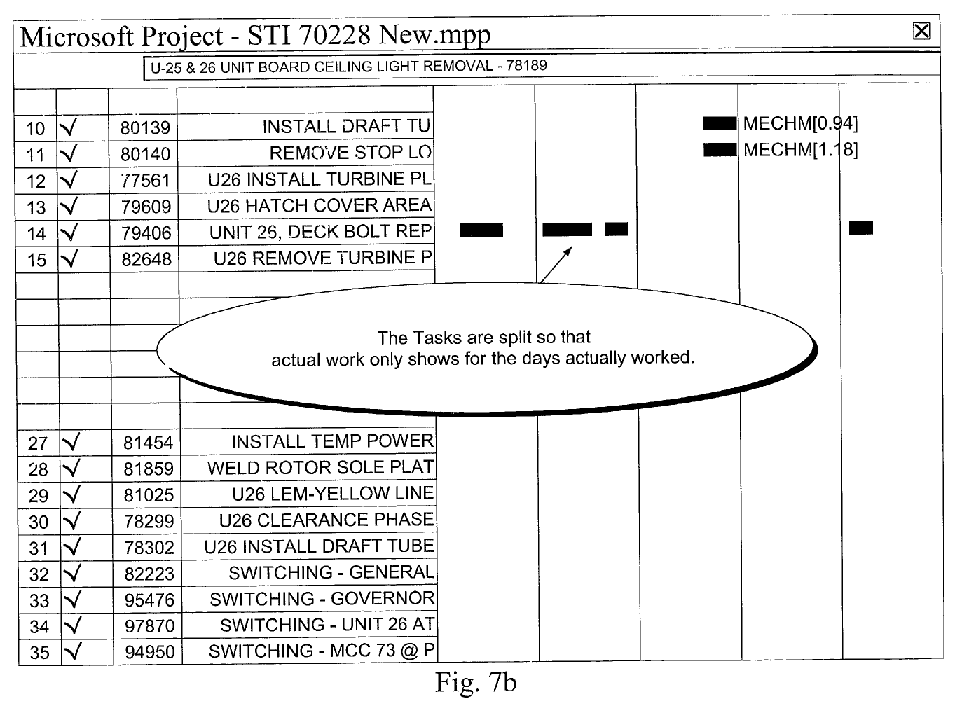

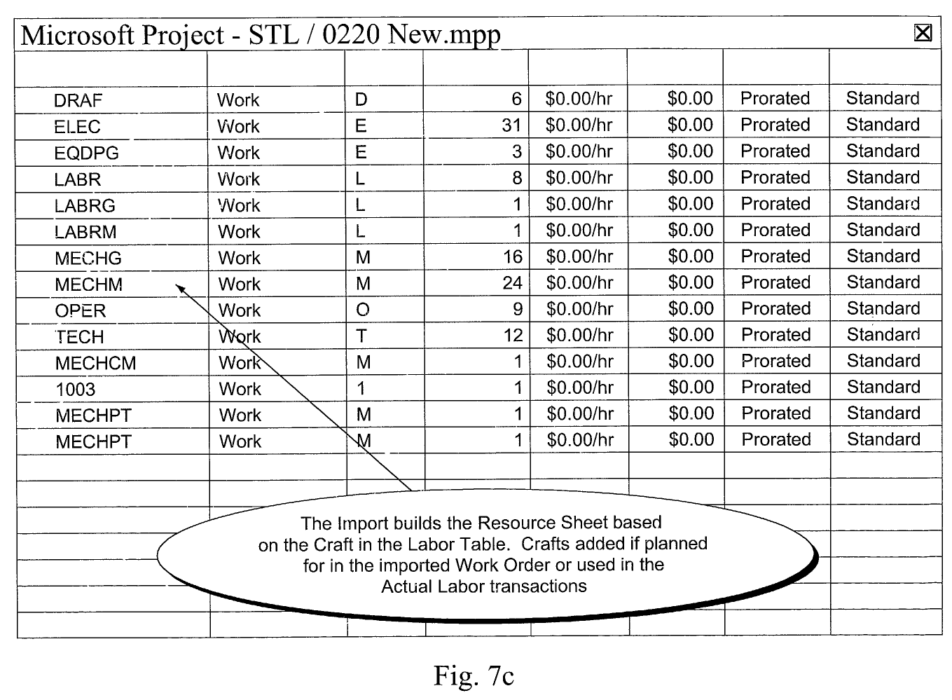

Referring to FIG. 6, the “Create MAXIMO Work Orders” display is shown. Here, the user may create work orders for the selected tasks or all task. The user may create work orders for tasks that were created in project 2000, and save dates in the work order as either no dates—schedule or target dates are not saved, target dates—start and finish date from task are saved in the work order as target start and target finish dates, and schedule dates—start and finish date from task are saved in the work order as scheduled start and scheduled finish dates.

There are various default values, which may be provided as follows:

Equipment #—Default Equipment number to use for each task;

Cost Center—Default Cost Center to use for each task;

Responsible Dept—Default Responsible Dept and Reporting Dept to use for each task; and Program—Default program to use for each task.

Equipment #, Cost Center, and Program are required.

If the responsible dept (Text8) is populated for the task, then the system will use this value for the responsible dept and reporting dept rather than the default.

If the user has assignments for the tasks, the program will create work plan labor records for these. If the user doesn't have both of the sections of the craft codes selected in the use craft code like option, then the craft codes written to the work plan labor records will not be correct. The user would then need to go into the work order tracking screen to fix these.

The program will create the work order hierarchy if there is a WBS in the project. The Location, GL Account, First Qualifier, Second Qualifier, Noun Name, FERC #, Facility 1, Critical Equipment, Performance Improvement, Benefitting Facility (Profit Center), Sub Location I, Sub Location 2, and Sub Location 3 come from the equipment number used in creating the work order. The work order priority is initially set to 0. The duration from the project is written to the estimated duration field. The estimated labor hours & cost are calculated from the Assignments used in the tasks. Either the Target or Scheduled dates are updated from the start and finish dates in the project, depending upon the selection made on the screen for the dates. The status used is WPROJECT which is a synonym for WAPPR. The equipment #, cost center, and program saved are from the screen values under the work order system defaults. The responsible department comes from the project. If the user has populated the responsible department column in the project (text8),the program will use this first. If this column is empty then it uses the value from under the work order system defaults. The system also uses this same value for the reporting department.

The description comes from the task name. Since most of the work order data bases have limited the description on the work order to 50 characters, the program only saves the first 50 characters of the task name. The activity field (WOPM 1) is populated with whatever value is in the text5 column in the project. The calendar field is populated with whatever value is in the text7 column in Project.

If there are assignments in the Project for the tasks used to create Work Orders, then the Interface will create Work Plan Labor records for the newly created Work Order using these assignments. If there is a WBS (Work Breakdown Structure) in Project for the tasks selected to be used to create Work Orders, then this hierarchy is copied to the Work Order system so that they will have the same dependencies. If the tasks to be used to create Work Orders have links, then these links are copied over to the Work Order system as sequences so that the work order will show the same order of work.

The “Where Clause” screen logic test button will test the SQL statement and if correct return the number of records found. The user may save queries for future use, or can delete queries no longer needed. The OK button returns the custom query to the active screen and the program uses it an the import.

The Interface is very flexible in its use, in that the users can build any type of schedule, from a weekly schedule, short range, to a long range schedule. To build a short term schedule, the users can select all of their responsible work orders that haven't been completed. Once these tasks are in Project, this working file can be maintained using the Interface. Completed Work Orders can be deleted, new Work Orders can be merged in, tasks can be progressed with their actual cost and labor from the Work Order system. The task can also be rescheduled, and then have those dates written back to the Work Order system.

From this working file, it is easy for the user to create a Weekly schedule using the features of Project. They can filter the tasks in their project to display only work that is scheduled or in progress for any date range. Once these tasks are displayed, they can then be copied to another project file or printed for distribution.

The “Where Clause” screen logic test button will test the SQL statement and if correct return the number of records found. The user may save queries for future use, or can delete queries no longer needed. The OK button returns the custom query to the active screen and the program uses it an the import.

Long range schedules can include major jobs, forecasted work based upon the PM data in the Work Order system, and overhead activities based on past history. Using the Interface, the users can forecast, the work planned as preventive maintenance many years in advance. They can then add to that major work planned, which could include project tasks from project files from outside vendors. They can then use Project to fashion a reasonable schedule, and using the feature to create Work Orders, automatically create Work Orders in their Work Order system that could have target schedule dates.

The Interface can also be used to duplicate major jobs to create Work Orders quickly. For repetitive jobs, such as overhauling an entire hydroelectric unit, which may be comprised of 500 individual work orders or more, this feature can be a time saver as well as a money saver. Since a hydro-electric plant may have many units that are exactly the same, designing one project to overhaul them can be used more than once. Once the job is completed, the planners can analyze the work done and rearrange scheduled tasks to shorten the length of the project. Once that is complete, they can then use the Create Work Order feature to create a completely new job for the next unit.

While preferred embodiments of the present invention have been shown and described, it will be understood by those skilled in the art that various changes or modifications can be made without varying from the scope of the invention.

I claim:

1. A computer system for work scheduling comprising at least one computer having a user interface, a first software program component accessible by the computer for generating work orders, a second software program component accessible by the computer for exchanging data between the first and second software program components so as to integrate the scheduling of project tasks with work order scheduling and to generate and update work orders for completing the scheduled project tasks.

2. The computer system of claim 1 further comprising a database accessible via at least one software program component and containing historical work order data.

3. The computer system of claim 1 further compressing a database accessible via at least one software program component and containing project scheduling data.

4. The computer system of claim 1 further comprising means for displaying an integrated project task and work schedule.

5. The computer system of claim 1 wherein the computer has means to communicate with at least one other computer via internet, intranet or LAN.

6. The computer system of claim 1 wherein multiple users can access the software program components for scheduling work, generating work orders and/or generating reports.

7. The computer system of claim 1 further comprising means for printing an output from the computer system.

8. The computer system of claim 1 further comprising means for inputting data from completed work and completed tasks and for updating the project schedule.

9. A method for integrating maintenance work assignments with project task assignments comprising:
providing a computer system;
providing a first software program component accessible via the computer system for generating work orders;
providing a second software program component accessible via the computer system for generating project tasks;
providing an integration software program for exchanging data between the first software program and the second software program so as to integrate scheduling of the work orders and project tasks, for generating an integrated schedule and for generating and updating work orders for completing the scheduled project tasks; and, using the computer system to generate an integrated maintenance and project schedule.
